(19) United States
(12) Patent Application Publication
(10) Pub. No.: US 2020/0074476 A1
(43) Pub. Date: Mar. 5, 2020

(54) ORTHOGONAL DATASET ARTIFICIAL INTELLIGENCE TECHNIQUES TO IMPROVE CUSTOMER SERVICE

(71) Applicant: T-Mobile USA, Inc., Bellevue, WA (US)

(72) Inventors: James Ellison, Issaquah, WA (US); Joel Werdell, Seattle, WA (US); Robert Stamm, Seattle, WA (US); Phi Nguyen, Bellevue, WA (US)

(21) Appl. No.: 16/556,131

(22) Filed: Aug. 29, 2019

Related U.S. Application Data
(60) Provisional application No. 62/725,138, filed on Aug. 30, 2018.

(51) Int. Cl. G06Q 30/00; G06N 20/00

(52) U.S. Cl. CPC G06Q 30/016; H04W 84/042; G06N 20/00

(57) ABSTRACT

A customer care system that uses machine learning to surface relevant information for resolving customer issues regarding cellular network service is provided. The system receives a set of incoming data that includes current information of a cellular network. The system applies the set of incoming data as input to a machine learning model to produce a set of predicted conclusions. The machine learning model is trained by using one or more sets of orthogonal datasets that includes historical information of the cellular network. The system maps the set of predicted conclusions to a remedial action and performs the remedial action to effectuate a change in the cellular network.

### CROSS-REFERENCE TO RELATED PATENT APPLICATION

This application claims priority to U.S. Provisional Patent Application No. 62/725,138, filed on Aug. 30, 2018, entitled “Orthogonal Data Set Artificial Intelligence Techniques to Improve Customer Service,” which is hereby incorporated by reference in its entirety.

### BACKGROUND

Customer care is the business of receiving feedback from customers regarding goods or services provided by an enterprise, and satisfactorily addressing the received feedback. In some cases, customer care is a tradeoff between the expense of maintaining a customer's satisfaction and the expense of losing a dissatisfied customer. On one hand, an enterprise generally desires to keep customers and to continue to receive revenue from these customers. The cost of acquiring a new customer is generally more expensive than maintaining an existing customer. On the other hand, if a customer is particularly difficult to satisfy, then the expense of maintaining that customer may make that customer unprofitable.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1A and FIG. 1B illustrate a customer care system that use orthogonal datasets and machine learning to provide customer care for a telecommunications enterprise.

FIG. 2 illustrates example training datasets for a machine learning model of the customer care system.

FIG. 3 illustrates an example customer care operation of the wireless telecommunications provider that uses the trained machine learning model.

FIG. 4 illustrates the customer care system using a machine learning model to proactively identify issues and perform remedial actions without customer input.

FIG. 5 is a block diagram showing various components of a computing device that implements the customer care system.

FIG. 6 conceptually illustrates a flow diagram of an example process for using a machine learning model to provide customer care for a wireless telecommunications provider.

### DETAILED DESCRIPTION

This disclosure is directed to a customer care system that uses orthogonal datasets and machine learning to lower the cost of providing customer care for a telecommunications enterprise. When a customer contacts a customer care service center of a wireless telecommunications provider, the customer care system applies a machine learning model based on information available to a cellular network provider to predict issues that the customer may be experiencing, and the customer care system then surfaces information in real time that is relevant to resolving the situation. The use of orthogonal datasets provides confidence in inferring context and predicting likely customer issues such that intrusive questions and unnecessary interactions may be minimized.

When using the machine learning model for customer care, different types of input are used to determine the type of issue that a customer is likely having. A wireless telecommunications provider may then provide information to the customer and the customer care representative (and potentially an escalation engineer) on a just-in-time and/or situational awareness basis. Examples of different types of input that are used as input to the machine learning model may include but are not limited to: (1) customer messages sent to the customer care service center of the wireless telecommunications provider; (2) billing status events (such as whether bills have been paid on time); (3) activity log (i.e. what the user has done in the past with his or her accounts); (4) network connectivity (i.e. whether calls have been dropped, and network reliability), (5) messages sent to the customer by the wireless telecommunications provider, and (6) account information. This input is used as orthogonal datasets because these different input types are in different domains, and they map to the same set of conclusions or outcomes, i.e. what issue or event is likely to arise with a customer. In some embodiments, historical versions of these different types of input are used as training data to create the machine learning model. Current or incoming data are applied as input to the created machine learning model to predict issues that the customers of the wireless telecommunications provider may experience.

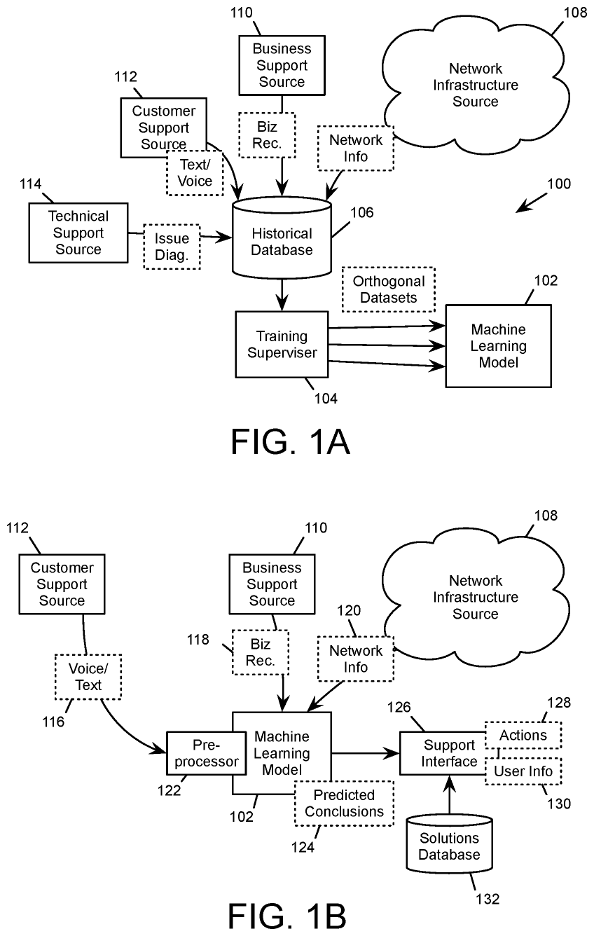

FIG. 1A and FIG. 1B illustrate a customer care system 100 that use orthogonal datasets and machine learning to provide customer care for a telecommunications enterprise such as a wireless telecommunications provider that operates a cellular network. FIG. 1A shows training a machine learning model 102 for the customer care system 100 using information that is available to the wireless telecommunications provider.

As illustrated in FIG. 1A, the training of the machine learning model 102 is conducted by a training supervisor 104. The training supervisor 104 has access to a historical database 106, which provides historical information related to the cellular network as training data for training the machine learning model 102. The historical database 106 stores status and events from various sources that are accessible to the wireless telecommunications provider, sources such as a network infrastructure source 108, a business support source 110, a customer support source 112, and a technical support source 114.

The network infrastructure source 108 includes information on the physical network infrastructure owned or operated by the wireless telecommunications provider in order to provide the network service to its cellular customers. The network infrastructure source 108 may provide network statistics, network status, network connectivity, equipment status, telemetry, and other network information, such as dropped call records (DCR) and other indicia of network reliability. The information provided by the network infrastructure source 108 may be generated by cellular towers, base stations, WiFi hotspots, routers, switches, servers, and other physical equipment owned or operated by the wireless telecommunications provider. The network infrastructure source 108 may also include information from outside of the network infrastructure of the wireless telecommunications provider. Such outside data may include records of service outages occurring elsewhere on the Internet, e.g., at a prominent public server or a popular website.

The business support source 110 includes information from hardware and software components that generates and maintains the business records for the wireless telecommunications provider, business records such as account information of customers, billing status or events (e.g., overdue bills, account balance, etc.), activity logs (e.g., what a customer has done in the past with his or her account), or service level agreements.

The customer support source 112 includes information from hardware and software components that receive and store messages between the customers and the customer care service center. These messages include reports of service outages, inquiry of billing issues, requests of technical assistance, and other communications from customers. A stored message may be a voice recording, an email, or a text message. In some embodiments, some of the stored messages are analyzed by a natural language processing engine, and the customer support source 112 stores the results of the natural language processing. In some embodiments, some of the stored messages are processed by sentiment analysis, and the results of the sentiment analysis are stored in the customer support source 112. In some embodiments, the customer support source 112 stores raw messages that are not further processed, and the natural language processing and/or the sentiment analysis are performed at the training supervisor 104.

The technical support source 114 includes information from hardware and software components that generate and store solutions, diagnosis, technical conclusions, or other relevant information regarding issues (issue diagnosis) that are either reported by customers or detected by the wireless telecommunications provider. The technical support source 114 may store the work product of technicians and engineers regarding various issues, including communications with customers. The technical support source 114 may also store the status or reports that are automatically generated by equipment operated by the wireless telecommunications provider.

The historical database 106 is a data store that stores training data for the machine learning model 102. In some embodiments, data from the network infrastructure source 108, the business support source 110, the customer support source 112, and the technical support source 114 are stored in the historical database 106 for the training supervisor 104 to access. In some embodiments, the historical database 106 includes a database interface that allows the training supervisor 104 to access data provided by the network infrastructure source 108, the business support source 110, the customer support source 112, and the technical support source 114.

The training supervisor 104 controls the generation and/or the training of the machine learning model 102. The training supervisor 104 identifies suitable data in the historical database for training the machine learning model 102, specifically orthogonal datasets. During a machine learning model generation phase, multiple orthogonal datasets are applied to a neural network, and then an unsupervised machine learning algorithm is used to identify categories of the datasets in the neural network and map the categories to conclusions to generate the machine learning model 102. In some embodiments, the result of the natural language processing and/or the sentiment analysis may be part of the orthogonal datasets used to train the machine learning model 102. In these embodiments, a preprocessor may perform the natural language processing and the sentiment analysis on the customer messages.

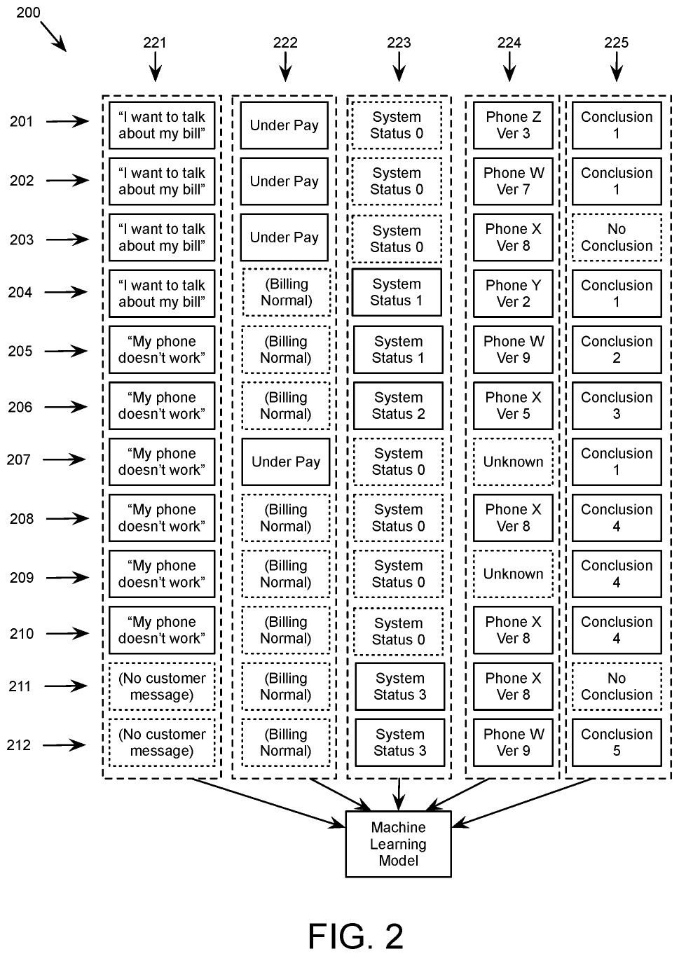

Orthogonal datasets are datasets that are in different domains, but which map to the same set of conclusions or outcomes and mutually bolster each other's accuracy. For example, a set of orthogonal datasets may include (1) a first dataset relating a statistically significant number of short message service (SMS) or multimedia messaging service (MMS) messages received by a customer care representative, mapped to the type of matter the customer care representative actually resolved; (2) a second dataset relating recent events that a customer experienced, mapped to matters for which the customer subsequently contacted a customer care representative. Orthogonal datasets will be further described by reference to FIG. 2 below.

FIG. 1B shows the customer care system 100 applying the trained machine learning model 102 to predict likely customer issues and/or to surface user information in real time based on information available to the wireless telecommunications provider. As illustrated, the machine learning model 102 is trained and deployed for customer care. Incoming data from the customer support source 112, the business support source 110, and the network infrastructure source 108 are applied to the trained machine learning model 102 as inputs. The customer support source 112 provides customer messages 116 as incoming data, which may include voice, text, email, or other types of messages from a customer regarding his or her cellular service, such as billing inquiry or request for technical assistance. The business support source 110 provides business records 118 as incoming data, which may include account information, billing events, activity logs, etc. The network infrastructure source 108 provides network information 120 as incoming data, which may include network statistics, network status, network connectivity, equipment status, telemetry, etc. that are generated near the time that the customer message is received. A preprocessor 122 may be used to perform natural language processing and sentiment analysis of the customer messages 116.

The machine learning model 102 generates a set of predicted conclusions 124 based on the input from the incoming data 116, 118, and 120. A support interface 126 may map the predicted conclusion 124 to a customer care protocol. The customer care protocol may include one or more remedial actions 128 and/or user information 130 based on the content of a solutions database 132 or other dynamic information available in the cellular network. The customer care system 100 may issue commands to the network infrastructure source 108 or the business support source 110 to implement the remedial action 128. The customer care system 100 may also present the user information 130 by e.g., surfacing information for the customer care representative or to send an SMS text message.

In some embodiments, the goal of the customer care system 100 is to provide just-in-time information based on situational awareness at a reduced cost. Just-in-time refers to ensuring that information be timely provided. Situational awareness refers to ensuring that the information provided is relevant. Providing information that is relevant just as a customer needs it ensures that customer care time can be spent on resolving an issue rather than on merely collecting information.

In some embodiments, the machine learning model 102 works by receiving a training dataset and applying it to a neural net. Generally, the neural net is a set of nodes with statistical weights between the nodes. Based on a set of inputs, the neural net biases a path through its nodes to terminate in a final node that corresponds to a conclusion. As each record in the training set is applied to the neural net, the neural net changes the statistical weights between the nodes. Upon completing the application of the training data to the neural net, the neural net in effect provides a summary of the training data. If a new record is input to the neural net, the machine learning model 102 makes a neural path towards a conclusion in agreement with the records in the training set that is most similar to the new record.

However, some training sets are more relevant to input than others. Specifically, there are pairs of datasets that can be used as training datasets to make more accurate conclusions, than when either the first or the second are used in isolation. Where a first dataset bolsters the accuracy of a second dataset and where a second dataset bolsters the accuracy of a first dataset mapped to the same set of conclusions, those datasets are considered orthogonal datasets. In fact, sets larger than two datasets can be orthogonal if datasets in the set are pairwise orthogonal.

For example, a first dataset is related to a statistically significant number of SMS text messages received by a customer care representative that is mapped to the type of matter that the customer care representative actually resolved. A second dataset is related to recent events that a customer experienced, mapped to matters that the customer subsequently contacted a customer care representative. Both the first and second datasets are input that is predictive of matters a customer care representative may receive. The first dataset is effective at determining the mood of a customer, but might be ambiguous about identifying the underlying issue. The second dataset bolsters the accuracy of the first dataset by linking customer experience with the underlying issue.

As a further example, a first dataset having an SMS text stating “I want to talk about my bill” is unclear as to whether there was an overpayment or an underpayment. But a second dataset having an event that the phone service was cut off due to non-payment would more definitively point to an underpayment rather than an overpayment.

In another example, a first dataset that includes the SMS message “I′d like to pay my bill” has an 89.2% confidence that the issue relates to payment. A second dataset that includes an activity log of the account that shows the wireless telecommunications provider had sent a text message to the customer warning that the customer account was in arrears may push the confidence that the user was an existing customer to over 90%. Additionally, further application of the activity logs of the customer as data in the data sets may further increase confidence.

FIG. 2 illustrates example training datasets 200 for the machine learning model 102 of the customer care system 100. The figure shows twelve rows 201-212, each row corresponds to a set of orthogonal datasets having a common conclusion that are used to train the machine learning model 102. The sets of datasets are shown as five columns 221-225, each column corresponding to a different type of input data (in different domains) used to train the machine learning model. Specifically, the column 221 corresponds to customer messages from the customer support source 112. The column 222 corresponds to business records (e.g., account and billing information) from the business support source 110. The column 223 corresponds to network events or status from network infrastructure source 108. The column 224 corresponds to user device information (e.g., phone type and/or software version number), which may be received from the business support source 110. Lastly, the column 225 corresponds to conclusions or diagnosis by engineers or technicians from the technical support 114. For some of the rows, one or more of the input types may be absent. For example, for the dataset at row 204, column 222 (input from business support) is absent. For the dataset at row 203, column 225 (conclusion from technical support) is absent. For the dataset at row 211, column 221 (customer message from customer support) is absent. In these instances, the neural network of the machine learning model 102 is expected to generalize based on the training datasets 200.

In some embodiments, the process of creating a machine learning model with orthogonal datasets is as follows: (1) identifying two or more pairwise orthogonal datasets with respect to a set of conclusions (or outcomes); (2) applying the datasets as training sets to a neural network of the machine learning model 102; (3) using an unsupervised machine learning algorithm to identify categories where at least one category is biased from inputs from at least two of the orthogonal datasets; (4) using the machine learning algorithm to map each category to at least one conclusion from the set of conclusions.

Once the machine learning model is created, the customer care system uses the machine learning model according to the following: (1) receiving input with elements corresponding to input from more than one of the orthogonal datasets; (2) applying optional filters to the input, potentially biasing (increasing the statistical weight) of at least one input (an example of an optional filter is to use emotion detection and mood detection in the customer message); (3) applying the received input to the machine learning model 102; and (4) receiving the conclusion (or outcome) from the machine learning model 102.

Once a conclusion is reached, the conclusion can be used to select a course of action based on the conclusion. This adds the following two steps to using the machine learning model: (5) based at least on the conclusion or outcome reached, selecting a customer care protocol mapped to the conclusion or outcome to set forth a course of action recommended; and (6) automatically perform at least one item in the selected protocol.

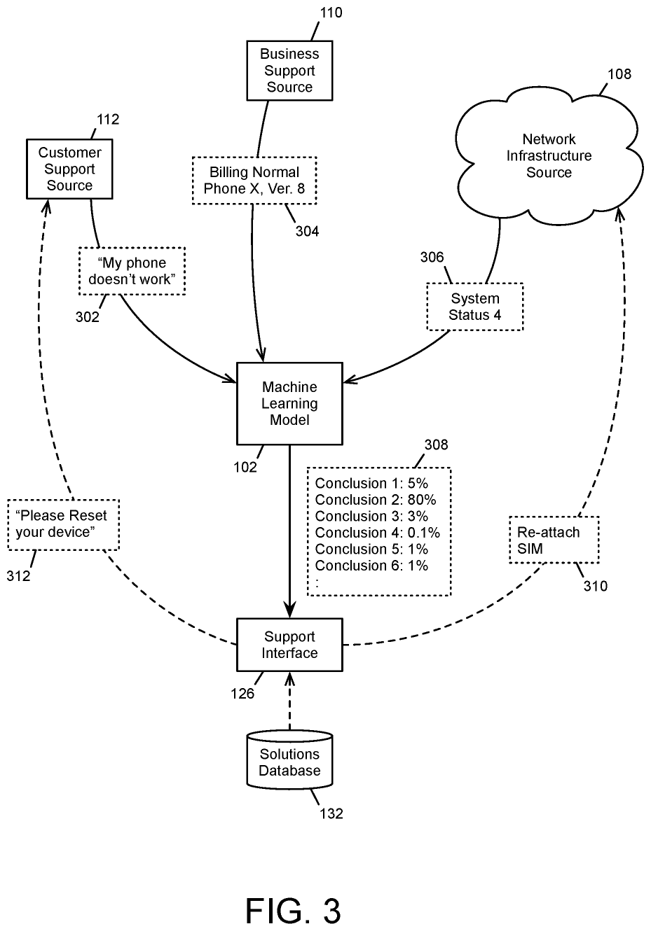

FIG. 3 illustrates an example customer care operation of the wireless telecommunications provider that uses the trained machine learning model 102. Specifically, the customer care system 100 applies customer messages and other data available to the wireless telecommunications provider to the machine learning model 102 as incoming data to obtain a conclusion. The support interface 126 maps the conclusion to a customer care protocol based on the content of the solutions database 132 and other static and dynamic information available to the wireless telecommunications provider.

As illustrated, the trained machine learning model 102 uses incoming data from several sources as input, including the customer support source 112, the business support source 110, and the network infrastructure source 108. In the example, the machine learning model 102 receives a text or voice customer message 302 from the customer support source 112 “My phone doesn't work”. The machine learning model 102 also receives account information 304 from the business support source 110 indicating that there is no billing issue with this account, and the customer's phone is type “X” with software version “8”. The machine learning model 102 also receives a network information 306 from the network infrastructure source 108, which indicates that the status of the network is “4”.

Based on these incoming data, the machine learning model 102 outputs a predicted conclusion 308, which indicates that conclusion “2” has the highest probability. The support interface 126 uses the solutions database 132 to map the predicted conclusion 308 to a customer care protocol that includes two actions 310 and 312. The action 310 is to command a network infrastructure source 108 of the wireless telecommunications provider to perform “re-attach SIM”. This is a remedial action that is performed by the wireless telecommunications provider without involving the customer. The action 312 is to present user information by e.g., surfacing information for the customer care representative or to send the customer an SMS text message. In this example, the user information is to instruct the customer to reset his or her device through the customer support source 112 of the wireless telecommunications provider, while the network infrastructure source 108 performs the action 310.

To further reduce the cost of providing care, the customer care system 100 may, prior to receiving a customer message, use the machine learning model 102 to proactively take remedial actions and surface user information based on issues that the enterprise detected on its own.

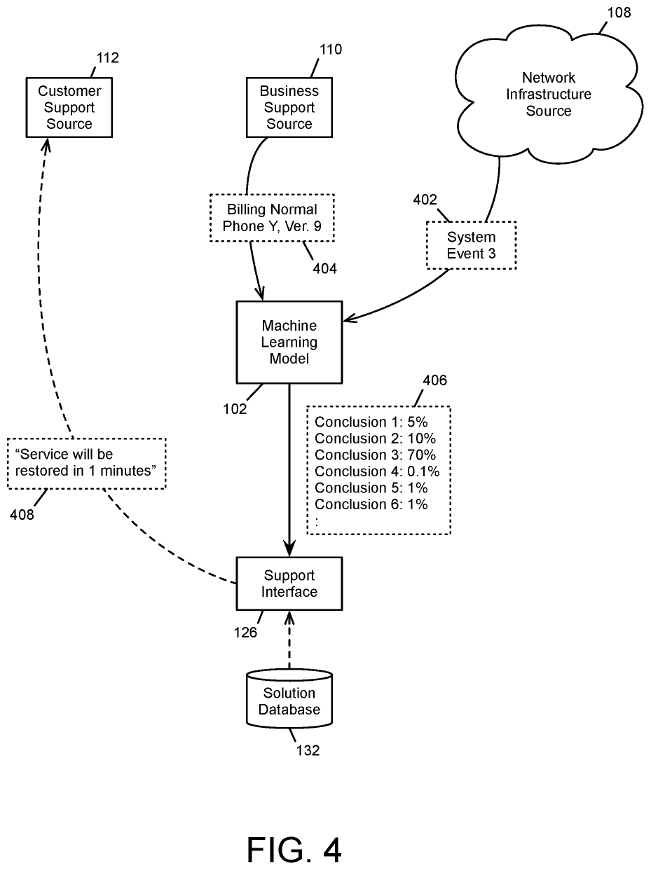

FIG. 4 illustrates the customer care system using machine learning model to proactively identify issues and perform remedial actions without customer input. As illustrated, the machine learning model 102 receives network information 402 from the network infrastructure source 108 indicating “system event 3”. The customer care system also receives account information 404 from business support source 110 that indicates there is an account having a user device that is phone “Y” with software version 9. The machine learning model 102 correspondingly outputs predicted conclusion 406, which indicates conclusion “3” has the highest probability. The support interface 126 in turn uses the solutions database 132 to map the predicted conclusion 406 to a customer care protocol that includes an action 408. The action 408 is to send an SMS text message to inform the customer that his or her phone will be ready in two minutes.

Customer care can be considered as a series of customer care stages that a customer issue goes through to be resolved. In some embodiments, the customer care system 100 determines the types of inputs that are applied to the machine learning model 102, and the type of information that is surfaced by the customer care system 100 is based on which customer care stage in which the customer issue currently resides.

At a first customer care stage, the customer is not aware of an issue. An enterprise may intervene by sending information notifying the customer of the problem proactively. In this way, the customer has more time to mitigate, and the issue may be resolved before the problem become serious. At this stage, the enterprise does not have to incur the expense of having a customer care representative handling a call from the customer. The machine learning model 102 is used to identify a conclusion and a corresponding set of actions without customer message, and the machine learning model 102 is used to automatically surface information based on issues that the enterprise detected on its own, e.g., based on incoming data from the network infrastructure source 108 or the business support source 110.

At a second customer care stage, the customer is aware of the issue, and the enterprise may intervene by sharing information, or making information readily accessible, such that the customer may self-resolve or “fix” their own issue such that the enterprise does not have to incur the expense of having a customer care representative handling a customer call. The machine learning model 102 is used to identify a conclusion and a corresponding set of actions without a customer message, and the machine learning model 102 is used to automatically surface information based on issues that the enterprise detected on its own, e.g., based on incoming data from the network infrastructure source 108 or the business support source 110.

At a third customer care stage, the customer calls a customer care representative to resolve the issue, and the customer care representative can resolve the issue quickly without escalating the issue to an engineering team. At this point, the enterprise may intervene by proactively collecting information to resolve an issue and sending the collected information to the customer care representative, or by requesting the customer to have the information to resolve an issue readily accessible upon calling the customer care representative. In these instances, if the enterprise can reduce the duration of each customer call by quickly surfacing relevant information, the enterprise may greatly reduce the expense of customer care person-hours. At this stage, the machine learning model 102 of the customer care system 100 may be used to automatically surface the information to resolve the issue based on the voice or the text of the customer message as well as based on incoming data from the network infrastructure source 108 or the business support source 110.

At a fourth customer care stage, the customer care representative cannot resolve the customer issue and may have to escalate by calling in a specialist such as a product or service engineer. At this point, the enterprise can route the issue to specialists known to have successfully resolved the same or similar issues in the past. In some circumstances, the enterprise or the customer representative may use the machine learning model 102 of the customer care system 100 to surface solutions or other relevant information generated by engineers or specialists to resolve previous similar issues. In this way, the time and cost of routing and rerouting the issue are minimized, and time to resolve the issue is reduced. At this stage, the machine learning model 102 of the customer care system 100 may be used to automatically surface the information to resolve the issue based on the voice or the text of the customer message as well as based on incoming data from the network infrastructure source 108 or the business support source 110.

In short, the use of orthogonal datasets provides a high enough confidence in inferring context and likely customer issues. The customer care system 100 may therefore eliminate intrusive dialog boxes used in online web troubleshoot forms and other unnecessary customer care interactions with the customer. In this way, an enterprise can use machine learning to intervene at different stages of customer care in order to provide information on a just in time and/or situational awareness basis.

### Example Computing Device

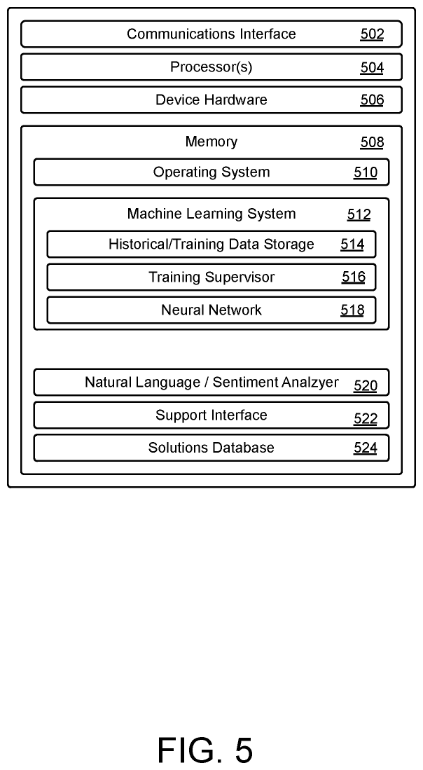

FIG. 5 is a block diagram showing various components of a computing device 500 that implements the customer care system 100. The computing device 500 implements the machine learning model 102 and communicates with the network infrastructure source 108, the business support source 110, the customer support source 112, and the technical support 114 to receive incoming data. During training, the computing device 500 uses the received data to train or generate the machine learning model 102. When deployed for customer care, the computing device 500 uses the received data as input to the machine learning model to produce predicted conclusions and to determine a course of action based on a customer care protocol.

The computing device 500 may be a general-purpose computer, such as a desktop computer, tablet computer, laptop computer, server, or an electronic device that is capable of receiving input, processing the input, and generating output data. The computing device 500 may also be a virtual computing device such as a virtual machine or a software container that is hosted in a cloud. Alternatively, the computing device 500 may be substituted with multiple computing devices, virtual machines, software containers, and/or so forth.

The computing device 500 may be equipped with one or more of the following: a communications interface 502, one or more processors 504, device hardware 506, and memory 508. The communications interface 502 may include wireless and/or wired communication components that enable the computing devices to transmit data to and receive data from other devices. The data may be relayed through a dedicated wired connection or via a communications network. The device hardware 506 may include additional hardware that performs user interface, data display, data communication, data storage, and/or other server functions.

The memory 508 may be implemented using a computer-readable medium, such as a computer storage medium. Computer-readable media include, at least, two types of computer-readable media, namely computer storage media and communications media. Computer storage media may include volatile and non-volatile, removable and non-removable media implemented in any method or technology for storage of information such as computer-readable instructions, data structures, program modules, or other data. Computer storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium that can be used to store information for access by a computing device. In contrast, communication media may embody computer-readable instructions, data structures, program modules, or other data in a modulated data signal, such as a carrier wave, or other transmission mechanisms.

The processors 504 and the memory 508 of the computing device 500 may implement an operating system 510 and various software. The various software may include routines, program instructions, objects, and/or data structures that are executed by the processors 504 to perform particular tasks or implement particular abstract data types. The various software implemented by the processors 504 and the memory 508 includes a machine learning system 512, which includes a historical or training data storage 514, a training supervisor 516, and a neural network 518. The processors 504 and the memory 508 also implements a natural language and/or sentiment analyzer 520, a support interface 522, and a solutions database 524.

The operating system 510 may include components that enable the computing devices 500 to receive and transmit data via various interfaces (e.g., user controls, communications interface, and/or memory input/output devices), as well as process data using the processors 504 to generate output. The operating system 510 may include a presentation component that presents the output (e.g., display the data on an electronic display, store the data in memory, transmit the data to another electronic device, etc.). The operating system 510 may include a hypervisor that allows the computing device to operate one or more virtual machines and/or virtual network components. Additionally, the operating system 510 may include other components that perform various additional functions generally associated with an operating system.

The machine learning system 512 implements the machine learning model 102 in the computing device 500. During training of the machine learning model, the data received from the network infrastructure source 108, the business support source 110, the customer support source 112, and the technical support 114 are stored in the historical and/or training data storage 514. The training supervisor 516 examines the data stored in the historical/training data storage 514 to identify orthogonal datasets, i.e., datasets that are in different domains yet support an identical conclusion. The neural network 518 is a program that implement the machine learning model based on parameters specifying interconnections, weights, and neurons of the neural network. The training supervisor 516 uses the identified orthogonal datasets to train the neural network 518 by modifying the various parameters of the neural network. When the machine learning model is deployed for customer care, data received from the network infrastructure source 108, the business support source 110, and the customer support source 112 are fed to the neural network 518 to obtain predicted conclusions as output.

In some embodiments, the machine learning model implemented by the computing device 500 may be trained at another computing device using orthogonal datasets and not at the computing device 500. In these instances, the parameters of the trained machine learning model (e.g., the weights and interconnections of the neural network 518) are delivered to the computing device 500 to be deployed for customer care.

The natural language and sentiment analyzer 520 is a program that processes customer generated messages as natural language and analyzes its emotional content. The text or voice of the customer message are analyzed to identify information of interest to the customer care system 100. The choice of words and intonation of the customer are analyzed to identify the emotion of the customer. The result of the analysis may be used to train the machine learning model or to obtain prediction conclusion when the machine learning model is deployed for customer care.

The support interface 522 is a program that maps the predicted conclusions produced by the machine learning system 512 to a customer care protocol that may include one or more remedial actions and/or user information. The customer care protocol is selected from the solutions database 524, which stores various possible customer care protocols for different possible conclusions. The support interface 522 may communicate the mapped remedial actions to hardware or software components controlled by the wireless telecommunications provider (e.g., the network infrastructure source 108) to effectuate the remedial action. The support interface may also communicate the mapped user information to the customer support source 112 to be used by the customer or the customer care representative.

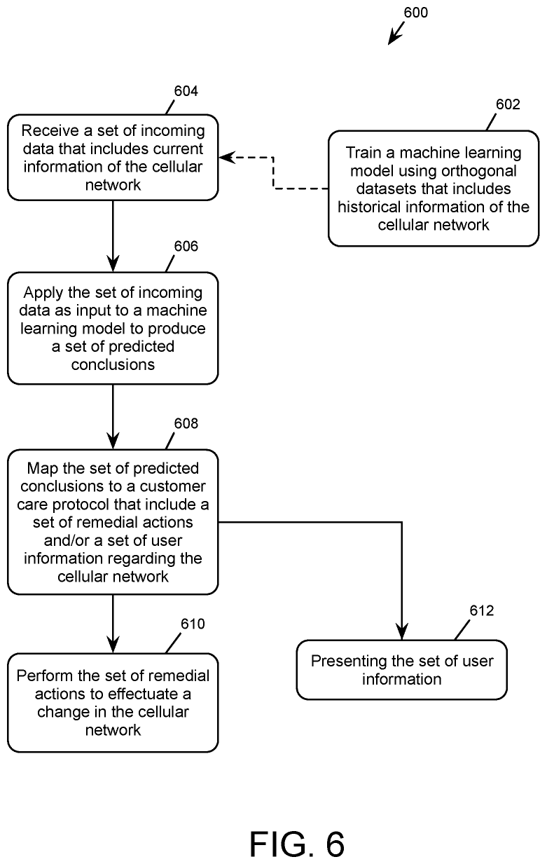

FIG. 6 conceptually illustrates a flow diagram of an example process 600 for using a machine learning model to provide customer care for a wireless telecommunications provider. In some embodiments, the process 600 is performed by the computing device 500 that implements the customer care system 100.

The process 600 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like, that perform particular functions or implement particular abstract data types. The order in which the operations are described is not intended to be construed as a limitation, and any number of the described blocks can be combined in any order and/or in parallel to implement the process.

At block 602, the customer care system trains a machine learning model using orthogonal datasets by using historical information of a cellular network. The historical information of the cellular network used for training the machine learning model may include historical network information (e.g., network connectivity), historical business records (e.g., account information, billing status and events, activity logs), customer messages (e.g., raw text or voice in natural language or already processed under natural language processing), issue diagnosis (e.g., diagnosis of the cellular network or of a customer account), etc. The customer care system may identify datasets that are in different domains yet support the same conclusion (e.g., having the same diagnosis of the cellular network or the same diagnosis of the customer account) as orthogonal datasets. In some embodiments, the operations of the block 602 are not performed at the computing device 500 but the parameters of the trained machine learning model are provided to the computing device 500.

At block 604, the customer care system receives a set of incoming data of the cellular network. The incoming data may include current information of the cellular network. The current information of the cellular network may include current network information (e.g., network connectivity), current business records (e.g., account information, billing status and events, activity logs), customer messages (e.g., raw text or voice in natural language or already processed under natural language processing), issue diagnosis (e.g., diagnosis of the cellular network or of a customer account), etc.

At block 606, the customer care system applies a machine learning model to produce a set of predicted conclusions based on the set of incoming data.

At block 608, the customer care system maps the set of predicted conclusions to a customer care protocol that may include a set of remedial actions and/or a set of user information regarding the cellular network.

At block 610, the customer care system performs the set of remedial actions to effectuate a change at the cellular network. The set of remedial actions may include configuring a particular component of the network infrastructure of the cellular network, or causing a change in the account information of the customer, etc.

At block 612, the customer care system presents the set of user information by e.g., transmitting the user information to the customer or displaying the user information to a customer care representative at a customer care service center. The set of user information may include an estimate of the time the customer has to wait for service to be restored, or an explanation of why the customer is experiencing a particular billing issue, etc.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media of a mobile/computing device storing computer-executable instructions that upon execution cause one or more processors to perform acts comprising:
receiving incoming data comprising current information of a cellular network;
applying the incoming data as input to a machine learning model to produce a set of predicted conclusions, wherein the machine learning model is trained by using one or more sets of orthogonal datasets comprising historical information of the cellular network;
mapping the set of predicted conclusions to a remedial action; and
performing the remedial action to effectuate a change in the cellular network.

2. The non-transitory computer-readable media of claim 1, wherein the incoming data further comprises a natural language message from a customer of the cellular network.

3. The non-transitory computer-readable media of claim 2, wherein the acts further comprise mapping the set of predicted conclusions to a set of user information regarding the cellular network and presenting the set of user information.

4. The non-transitory computer-readable media of claim 1, wherein a set of orthogonal datasets comprise two or more datasets that are in different domains and support an identical conclusion.

5. The non-transitory computer-readable media of claim 4, wherein the set of orthogonal datasets is associated with an issue diagnosis that supports the conclusion.

6. The non-transitory computer-readable media of claim 4, wherein the set of orthogonal datasets comprises at least one of historical business records and historical network information of the cellular network.

7. The non-transitory computer-readable media of claim 1, wherein the current information of the cellular network comprises at least one of current business records and current network information of the cellular network.

8. A system comprising:
one or more processors; and
a computer-readable medium storing a plurality of computer-executable components that are executable by the one or more processors to perform a plurality of actions, the plurality of actions comprising:
receiving incoming data comprising current information of a cellular network;
applying the incoming data as input to a machine learning model to produce a set of predicted conclusions, wherein the machine learning model is trained by using one or more sets of orthogonal datasets comprising historical information of the cellular network;
mapping the set of predicted conclusions to a remedial action; and
performing the remedial action to effectuate a change in the cellular network.

9. The system of claim 8, wherein the incoming data further comprises a natural language message from a customer of the cellular network.

10. The system of claim 9, wherein the plurality of actions further comprise mapping the set of predicted conclusions to a set of user information regarding the cellular network and presenting the set of user information.

11. The system of claim 8, wherein a set of orthogonal datasets comprise two or more datasets that are in different domains and support an identical conclusion.

12. The system of claim 11, wherein the set of orthogonal datasets is associated with an issue diagnosis that supports the conclusion.

13. The system of claim 11, wherein the set of orthogonal datasets comprises at least one of historical business records and historical network information of the cellular network.

14. The system of claim 8, wherein the current information of the cellular network comprises at least one of current business records and current network information of the cellular network.

15. A computer-implemented method, comprising:
receiving incoming data comprising current information of a cellular network;
applying the incoming data as input to a machine learning model to produce a set of predicted conclusions, wherein the machine learning model is trained by using one or more sets of orthogonal datasets comprising historical information of the cellular network;
mapping the set of predicted conclusions to a remedial action; and
performing the remedial action to effectuate a change in the cellular network.

16. The computer-implemented method of claim 15, wherein the incoming data further comprises a natural language message from a customer of the cellular network.

17. The computer-implemented method of claim 16, further comprising mapping the set of predicted conclusions to a set of user information regarding the cellular network and presenting the set of user information.

18. The computer-implemented method of claim 15, wherein a set of orthogonal datasets comprise two or more datasets that are in different domains and support an identical conclusion.

19. The computer-implemented method of claim 18, wherein the set of orthogonal datasets is associated with an issue diagnosis that supports the conclusion.

20. The computer-implemented method of claim 18, wherein the set of orthogonal datasets comprises at least one of historical business records and historical network information of the cellular network.
